(19) United States
(12) Patent Application Publication
(10) Pub. No.: US 2009/0315315 A1
(43) Pub. Date: Dec. 24, 2009

(54) BOTTLE ADVERTISEMENT

(75) Inventor: Chahdad BOLOURI, Great Falls, VA (US)

Correspondence Address: GREENBLUM & BERNSTEIN, P.L.C., 1950 ROLAND CLARKE PLACE, RESTON, VA, 20191, US

(73) Assignee: NCC, INC., McLean, VA (US)

(21) Appl. No.: 12/142,241

(22) Filed: Jun. 19, 2008

(51) Int. Cl. B42D 15/00; B42D 15/10; G06Q 30/00

(52) U.S. Cl. 283/56; 283/81; 705/14.4

(57) ABSTRACT

An advertising device including a container configured to hold contents; and a label removably adhered to the container; the label including indicia thereon identifying one of a product complementary to the container contents, and a product related to the container contents. A method of advertising including providing a container configured to hold contents; providing a label removably adhered to the container; and providing indicia on the label identifying one of a product complementary to the container contents, and a product related to the container contents.

### BACKGROUND OF THE INVENTION

1. Field of the Invention

The present invention relates to a container with a removable label, and more particularly, to a bottle advertisement and a method of advertising.

2. Description of the Related Art

There are different types of labeled containers known in the art. For example, U.S. Pat. No. 6,991,261 to DRONZEK et al. discloses a plastic bottle having a label with a removable portion. U.S. Pat. No. 6,849,147 to HAVARD et al. discloses a beverage bottle having a label with a piggyback portion. U.S. Pat. No. 6,622,878 to FREY discloses a container with a removable label fixed over a silk-screened portion thereof. U.S. Pat. No. 6,129,959 to MERCER et al. discloses a plastic bottle having a label with a removable portion. U.S. Pat. No. 5,282,534 to LAPP discloses an egg carton having a removable label for containing a pack of coupons directed to products related to the eggs, such as bacon. LAPP teaches that the container may be a different type of container, such as a pill bottle or milk carton.

It is known in the art of advertising that the consumer's attention must be captured quickly. For example, the best results will more likely be obtained if an advertisement captures a potential customer's attention in three seconds or less.

### SUMMARY OF THE INVENTION

The present invention is directed to a bottle advertisement and to a method of advertising, which address problems and omissions in the prior art.

An aspect of the present invention provides a container including a body; and a label removably adhered to the body. A further aspect of the present invention provides a method of advertising including providing a container, and providing an advertising label removably adhered to the container.

An aspect of the present invention provides an advertising device including a container configured to hold contents; and a label removably adhered to the container; the label including indicia thereon identifying one of a product complementary to the container contents, and a product related to the container contents. In a further aspect of the present invention, the advertising device includes indicia permanently printed on the container; the indicia positioned on the container and covered by the label so that removal of the label exposes the indicia. Further, the advertising device may include indicia permanently printed on the container; the indicia positioned on the container so as to be uncovered by the label and visible. In the present invention, the container may include a bottle; and the contents may include a beverage. Further, the label may include perforations thereon so that a portion of the label is removable from the container.

A further aspect of the present invention provides a method of advertising including providing a container configured to hold contents; providing a label removably adhered to the container; and providing indicia on the label identifying one of a product complementary to the container contents, and a product related to the container contents.

### BRIEF DESCRIPTION OF THE DRAWINGS

The above and other objects, features, and advantages of the present invention will be made apparent from the following description of the preferred embodiments, given as nonlimiting examples, with reference to the accompanying drawings in which:

FIG. 1 is a front view of the bottle advertisement of a first embodiment of the present invention;

FIG. 2 is a front view of the bottle advertisement of a second embodiment of the present invention;

FIG. 3 is a front view of the bottle advertisement of a third embodiment of the present invention; and

FIG. 4 is a front view of the bottle advertisement of a fourth embodiment of the present invention.

### DETAILED DESCRIPTION OF THE INVENTION

The particulars shown herein are by way of example and for purposes of illustrative discussion of the embodiments of the present invention only and are presented in the cause of providing what is believed to be the most useful and readily understood description of the principles and conceptual aspects of the present invention. In this regard, no attempt is made to show structural details of the present invention in more detail than is necessary for the fundamental understanding of the present invention, the description is taken with the drawings making apparent to those skilled in the art how the forms of the present invention may be embodied in practice.

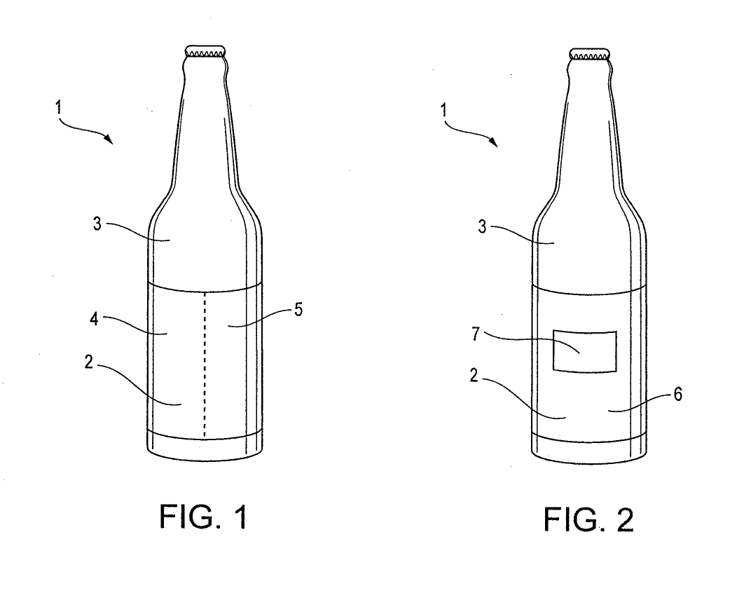

The present invention is directed to a bottle advertisement. With reference to FIGS. 1-4 of the drawings, reference numeral 1 denotes a bottle advertisement of the present invention. In a first embodiment, the bottle advertisement 1 includes a label 2 and a bottle 3. The bottle 3 may, for example, be a beverage bottle, and include a body and a neck. The label 2 may be adhered to a bottle at various locations. For example, the label may be adhered around the body of the bottle. In such a case, the label may extend completely around the circumference of the bottle, or the label may extend only partially around the circumference of the bottle. Additionally, the label may substantially cover the entire bottle, i.e., from the bottom of the body all the way to the top of the neck, with the label being partially or completely removable. For example, the label may include an easy tear portion to facilitate removal of the label. The label may include a perforated portion such that a portion of the label is removable, with the remainder of the label being torn at the perforation and remaining on the bottle. The label may be a shrink wrap type label completely covering the entire bottle, except for the cap, that is removable to expose a new design underneath the label. Further, the label may cover the entire bottle, including the bottom surface and the cap. This label may include perforations for easy removal of the label or portions of the label, in order to remove the cap and open the bottle. For example, a plurality of portions of the label may be removable, such as in strips, so that several portions of the bottle are exposed. The exposed bottle may include an additional, lower label having a design thereon. The label may cover only the upper portion of the neck and the cap, such that the label must be removed in order to remove the cap and open the bottle. The label may be removable to reveal a new design or information underneath.

Further, the label 2 may include different types of indicia or a combination of types of indicia thereon. For example, any of the labels may include words, numbers, pictures, or a combination of these, which identify the product in the bottle or the manufacturer of the bottle and contents. Further, the labels may include coupons for additional products or different or related products, or prize entry tickets, games, riddles, or other types of entertainment. The labels and the container could represent complementary products, articles, or items. For example, a beverage bottle could include a label having an advertisement or information about baseball. The labels could also be affixed to complementary articles or items that are not containers. For example, a label advertising chalk could be affixed to a cue stick. The labels could themselves comprise a game. For example, the labels may include indicia thereon including questions. When the label is removed, the answer to the question is revealed. Alternatively, the labels could comprise game tickets, such that when a portion of the label is removed, a particular ticket is revealed. The indicia could be on the reverse side of the label, or could be underneath the label, printed on the bottle or printed on an underlying label.

Further, the label 2, or a portion of the label 2, is removable from the bottle 3. In this regard, for a label 2 that is completely removable, the entire label 2 is removably adhered to the bottle 3. For a label 2 that is partially removable, a portion 4 of the label 2 may be removable leaving a portion 5 of the label 2 adhered to the bottle 3, as shown in FIG. 1. Alternatively, in a second embodiment as shown in FIG. 2, for a label 2 that is partially removable, a portion 6 of the label 2 may be permanently adhered to the bottle 3 and a portion 7 of the label 2 may be removable from the label 2 or removable from the bottle 3.

The labels may be adhered to the bottle with glue of several types. For example, the labels may be attached to the bottle with a glue which makes the label substantially permanently attached; or with a glue that makes the label removable. For example, a removable label may include a label that is removable a single time. Further, the removable label may include a label that may be removed, replaced, and then removed again a plurality of times.

The labels may also be manufactured of appropriate materials and include appropriate inks. The labels could be glow-in-the-dark or fluorescent and/or include inks that are glow-in-the-dark or fluorescent.

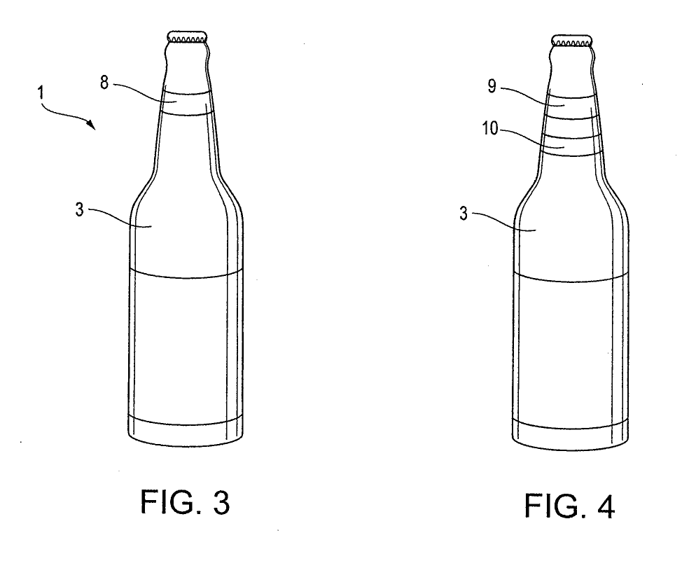

In a third embodiment of the present invention as shown in FIG. 3, the bottle advertisement 1 includes a bottle 3 and a label 8. The label 8 may be in addition to or alternative to the label 2. The label 8 is positioned around the neck of the bottle 3. The label 8 may include various types of indicia. Further, the label 8, or a portion of the label 8, may be removable from the bottle 3. In this regard, the entire label 8 may be completely removable from the bottle 3; or a portion of the label 8 may be removable from the bottle 3 or from the label 8. In a fourth embodiment of the present invention as shown in FIG. 4, the bottle advertisement 1 of the present invention includes a first label 9 positioned around the neck of the bottle 3 and a second label 10 positioned around the neck of the bottle. In this embodiment, the labels 9, 10 may include indicia. Further, the labels 9, 10 may be removable, including completely removable or partially removable. Additionally, the label 9 may be different from the label 10. In this regard, for example, the label 9 may be completely removable and the label 10 may be partially removable.

The labels may be particularly shaped. For example, the label may have the shape of the manufacturer's mark, or the shape of the contents, or the shape of the related product. Additionally, the removable or permanent labels may be positioned in other advantageous locations on the bottle. For example, removable or permanent labels may be positioned on the bottom of the bottle 3 or on the cap of the bottle 3.

The labels described above, including labels 2, 8, 9, 10, and the label portions including label portions 4, 5, 6, 7, may include a combination of types of indicia thereon, such as product identification marks, product description, nutrition information, directions for use, reproductions of photographs, and drawings. Further, the removable label portions may include product advertisements thereon. For example, the product advertisements may include a coupon or advertisement for a product that is related to or complementary to the product in the bottle 3. For example, if the product in the bottle 3 is beer, the removable label portion may include a coupon or advertisement for chips or nuts, or for a different type of beer, or for a sports event. Further, the labels may include indicia including games. For example, a removable label may include a joke or riddle, and the label may be removed to reveal the answer or punchline. Further, the labels may include games that include prizes, such that removing a label will reveal the purchaser's winning prize.

Additionally, the bottle 3 in the above described embodiments may include silk screen printing thereon. The silk screen printing may include product identification and information, and manufacturer's information. The silk screen printing may also include advertisements for alternative products or related products. The silk screen printing may be partially or completely covered by a removable label. In this manner, the bottle with the silk screen printing is reusable. A label may include portions that are removable and portions that are not removable. For example, a label may include a removable coupon or advertisement. Further, a label may include a removable game piece or riddle. When the removable portion is removed, the silk screen printing becomes exposed. The exposed silk screened portion may include product information, advertising information for the product or related products, or game information or an answer to a riddle. Additionally, the bottle advertisement of the present invention may include a first advertisement in a first format and a second advertisement in a second format. For example, the bottle advertisement may include a first advertisement in a silk screen printing and a second advertisement on a removable label. Further, the bottle advertisement may include additional advertisements in the same or different formats. For example, the bottle advertisement may include a third advertisement in a removable label format, in addition to the first and second advertisements. The bottle advertisement may also include any number of additional advertisements in the same or different formats.

Although the invention has been described with reference to an exemplary embodiment, it is understood that the words that have been used are words of description and illustration, rather than words of limitation. Changes may be made within the purview of the appended claims, as presently stated and as amended, without departing from the scope and spirit of the invention in its aspects. Although the invention has been described with reference to particular means, materials, and embodiments, the invention is not intended to be limited to the particulars disclosed. Rather, the invention extends to all functionally equivalent structures, methods, and uses such as are within the scope of the appended claims.

1. An advertising device comprising:
a container configured to hold contents; and
a label removably adhered to the container;
the label including indicia thereon identifying one of a product complementary to the container contents, and a product related to the container contents.

2. The advertising device according to claim 1, further comprising;
indicia permanently printed on the container;
the indicia positioned on the container and covered by the label so that removal of the label exposes the indicia.

3. The advertising device according to claim 1, further comprising;
indicia permanently printed on the container;
the indicia positioned on the container so as to be uncovered by the label and visible while the label is adhered to the container.

4. The advertising device according to claim 1;
the container comprising a bottle; and
the contents comprising a beverage.

5. The advertising device according to claim 1;
the label including perforations thereon so that a portion of the label is removable from the container.

6. A method of advertising comprising:
providing a container configured to hold contents;
providing a label removably adhered to the container;
providing indicia on the label identifying one of a product complementary to the container contents, and a product related to the container contents;
and advertising the contents and the complementary or related product with the container.

7. The advertising method according to claim 6, further comprising;
providing indicia permanently printed on the container;
the indicia positioned on the container and covered by the label so that removal of the label exposes the indicia.

8. The advertising method according to claim 6, further comprising;
providing indicia permanently printed on the container;
the indicia positioned on the container so as to be uncovered by the label and visible while the label is adhered to the container.

9. The advertising method according to claim 6;
wherein providing the container comprises providing a bottle; and
providing contents comprising a beverage.

10. The advertising method according to claim 6, further comprising;
providing perforations on the label so that a portion of the label is removable from the container.
